(19) United States
(12) Patent Application Publication
(10) Pub. No.: US 2009/0087137 A1
(43) Pub. Date: Apr. 2, 2009

(54) PLANAR LIGHTWAVE CIRCUITS WITH AIR FILLED TRENCHES

(76) Inventor: My The Doan, Calgary (CA)

Correspondence Address: My The Doan, 83 Hampshire Close, NW, Calgary, AB, T3A 4X9, CA

(21) Appl. No.: 11/866,402

(22) Filed: Oct. 2, 2007

(51) Int. Cl. G02B 6/12

(52) U.S. Cl. 385/14

(57) ABSTRACT

An air filled trench is formed underneath the waveguide to reduce propagation loss, which in turn allowing the waveguide to be in the close proximity of on-chip devices, such as a photodetector. The air filled trench is formed from the back side of the substrate; hence it would not disturb the integration and the formation of components on the front side of the substrate. In another embodiment, for silicon-on-insulator (SOI) based device, with an air filled trench and a metal electrode, a back gate is formed. In yet another embodiment, air filled trench also reduces the substrate loss of RF passive components and passive antenna operating in Giga Hertz range. Air filled trenches can be used for both photonic and electronic circuits in a planar lightwave circuit. Finally, another embodiment is for the trench to effectively guide gases and fluids to pass through the detection area.

### BACKGROUND OF THE INVENTION

(1) Field of the Invention

The invention relates to the formation of low loss planar lightwave circuit, more particularly to the use of air filled trench to reduce loss due to the substrate and to make the integration of waveguide to on-chip device easier.

(2) Background

There are various methods to integrate optical components and electronics for networking, sensing and displays. The current and popular method is the hybrid integration of various components such as laser diodes, photodetectors, waveguides and VLSI chips on a silicon optical bench, as described in Kitigawa et al., “Hybrid Integration Technologies using planar lightwave circuits and developed components,” IEICE Trans. Electron, Vol. E85-C, No. 4, April 2002, p. 1009. Each of the components are picked, aligned, placed and bonded onto a silicon substrate using flip chip technology. The performance of such module is sensitive to the alignments among the optical components such as between the fiber and waveguide, between the waveguide and the laser, and between the waveguide and the photodetector. The alignment constraints become tighter with increasing speed. Furthermore, the total cost of such module is dominated, at least 50%, by the costs of packages and associated assembly. The challenges then, are to improve the performance and to reduce cost of such module for future planar lightwave circuits (“PLC”).

One approach is by wafer bonding. This method reduces several processing steps (i.e. multiple modules at the same time, instead of picking individual components for each module), as well as improving alignment accuracy through a single step global alignment. U.S. Pat. No. 6,859,571 B2 to Kimerling describes a hybrid device comprising an optical chip and an electronic chip. The two chips are bonded together using solder bumps. U.S. Pat. No. 7,203,387 B2 to Doan discloses another method of VLSI-photonic heterogeneous integration by wafer bonding. The optical and electronic substrates are bonded through protruding metal pillars and pads.

The other approach is by monolithic integrated on a single chip. A popular PLC is the optical receiver, where waveguides are integrated with photodetectors.

In the convention waveguide, light is confined by total internal reflection inside of a high refractive index layer surrounded by regions of lower refractive index cladding layers. The evanescent field just outside of the waveguide decays exponentially with distance. The evanescent field strength is just a fraction of the field intensity inside the waveguide. However, often the waveguide and its cladding layers situate on a substrate that has a much higher refractive index. If the distance, d, between the waveguide and the substrate (or thickness of the lower cladding) is not thick enough, light would leak to the much higher refractive index region, the substrate. While we do not want light to leak to the substrate (i.e. d is large) when waveguide guides light, we do want light to couple to the photodetector (i.e. d is as small as possible). For low index difference waveguide where delta n, the difference between the refractive index of the waveguide and the refractive index of the cladding, equals 0.015, such as silicon oxynitride waveguide embedded in silicon oxide cladding, the lower cladding thickness can be as large as 8 um to avoid leaky optical loss to silicon substrate. For high index difference waveguide where delta n equals 0.55, such as silicon nitride core and silicon oxide cladding, the lower cladding thickness is still about 2.5 to 3 μm. On the other hand, because evanescent field strength decays exponentially with distance and is just a fraction of the total input field, d should be less than 0.4 μm for high index waveguide and less than 1.5 μm for low index waveguide to have good evanescent coupling to the photodetector. Normal practice is to keep d large to avoid coupling loss and to find methods to improve the coupling at the photodetector region.

Prior arts use optical tap, optical grating coupler, stacked antiresonant reflecting optical waveguide coupler, or to form substrate with different heights, in order to improve the efficiency in getting guiding light to the photodetector.

US patent application, 20050111777, describes a method to monolithically integrate optical waveguide (or optical interconnect) to photodetector using optical tap. U.S. Pat. No. 7,065,271 B2 to Zheng et al, discloses another method to direct light from optical waveguide to photodetector. It is by optical grating coupler. FIG. 1 shows that the waveguide, 102, the grating structure, 105, the lower cladding 101, and the photodetector, 104. The grating structure causes a portion of the light to reflect at different angles when light strikes the n3-n2 interface, and resulting in high incident angle when it continues on to hit the n2-n1 interface, causing it to penetrate to the lower cladding, and eventually to be captured by the photodetector.

There are other methods to overcome the large coupling distance. One method is to design a 45 degree mirror (using metal such as aluminum or gold) in combination of vertical pillar (with refractive index the same as that of waveguide) to deflect light down to the photodetector. This method requires complex integration and processing technique. Another method is to use vertical antiresonant reflecting optical waveguide coupler as described in Ikuta et al, “Stacked ARROW vertical coupler with large tolerance and short coupling length for three-dimensional interconnects,” Electron. Letters, Vol. 34, p. 1851, 1998. This method works well for dense integration of photonic circuits; but it is difficult to integrate with electronic circuits. One is because of the differences in dielectric materials. Even if we can overcome this, this method involves many extra processing steps and photolithography masking steps; hence it is an expensive method.

Finally, in U.S. Pat. No. 6,804,440 B2, Lee uses a substrate with different heights to make it possible for the waveguide to be in close proximity of the photodetector. The differential heights were formed by many sequences of photolithography, etching, filling, and planarization steps.

In summary, there is a trade-offs between ease of integration and high performance of the PLC.

### SUMMARY OF THE INVENTION

A principle object of the present invention is to provide an effective and very manufacturable method to integrate photonic and electronic components easier.

Other objects will appear hereinafter.

In accordance with the present invention, by reducing the optical loss due to evanescent coupling to substrate, integration of photonic and electronic components would be made simpler. Reducing the optical loss due to evanescent coupling to the substrate is achieved by removing the silicon under the waveguides and their cladding, resulting in air filled trenches. Since refractive index of air is much less than that of the waveguide and cladding materials, the critical angle is lower; so, much of the incident light would reflect back when it hits the interface of dielectric and air. Some reflecting light can refract back to the core of the waveguide. Furthermore, using this invention the cladding may be made thinner and hence the distance between the waveguides and photodetectors is smaller, which in turns allowing higher optical coupling's efficiency. It would work well with direct evanescent coupling, or optical grating coupler, or slant mirror.

Forming air filled trenches is achieved in the following manner. After all the processing steps on the front side of the wafer completed, the wafer will be thin down to a predetermined thickness. Then after back side clean, standard photolithography processes will proceed, using alignment marks on the front side to align the trenches' features. The next step is to etch silicon in the areas that are opened by the photolithography processes from the back side of the wafer until it reaches the bottom of the dielectric layer on the front side of the wafer. The final steps are clean, resist strip and clean. In summary, this embodiment requires only one extra masking step, and its associate etching, and cleaning steps. This embodiment also does not disturb the standard integration on the front side of the wafer.

In a further embodiment, forming air filled trench under the waveguide will enhance the performance of device which uses waveguide for guiding the light. One such device is a dispersion compensation device which is disclosed by Ogawa and Tan in US patent application, 20060093299.

According to this embodiment, the propagation loss will be reduced and there is a possibility to add a back gate to better control of the carrier density in the photonic crystal region.

In a still further embodiment, air filled trench also reduces the substrate effects in RF passive components. Hence in a PLC, air filled trench can be applied to both the optical and RF components.

Finally, another embodiment is disclosed, wherein said the trenches are useful if the PLC is used for sensing. The trench allows sensitive detection of small amounts of samples.

The above and other objects, features and advantages of the present invention will be better understood from the following detailed description taken in conjunction with the accompanying drawings.

### BRIEF DESCRIPTION OF THE DRAWINGS

FIG. 1 shows a prior art where optical grating coupler is used to redirect light from waveguide to the photodetector.

FIG. 2 illustrates the ends views and side view of the embodiment, where air filled trench under the waveguide is formed to greatly reduce the evanescent coupling loss due to the substrate. The thickness d1 can be designed to be much thinner than d2 to allow the waveguide to be in the proximity of the photodetector.

FIG. 3a shows the results of optical field with respect to the y-axis of a SiN waveguide locates 2.0 μm above a silicon substrate, using 2D optical waveguide mode solver.

FIG. 3b shows the results of optical field with respect to the y-axis of a SiN waveguide locates 0.1 μm above a silicon substrate with air filled trench, using 2D optical waveguide mode solver.

FIG. 4 shows the end view of the embodiment, where a metal layer is added after the air filled trench was formed.

FIG. 5 shows the end view of the embodiment, where a metal layer was used as a photoresist to form the air filled trench and was left as a ground contact.

FIG. 6 illustrates another embodiment, where air filled trench is used in photonic circuit that is based on SOI substrate.

FIG. 7 illustrates a dispersion compensation device that makes used of air filled trench.

FIG. 8 shows with air filled trench, a second gate electrode can be added.

FIG. 9 shows another embodiment, wherein said an air filled trench can be applied to both RF passive components, and optical waveguides.

FIG. 10 illustrates another embodiment, wherein in an optical sensor the trench is used as a channel to guide gases or fluids flowing across the detection area.

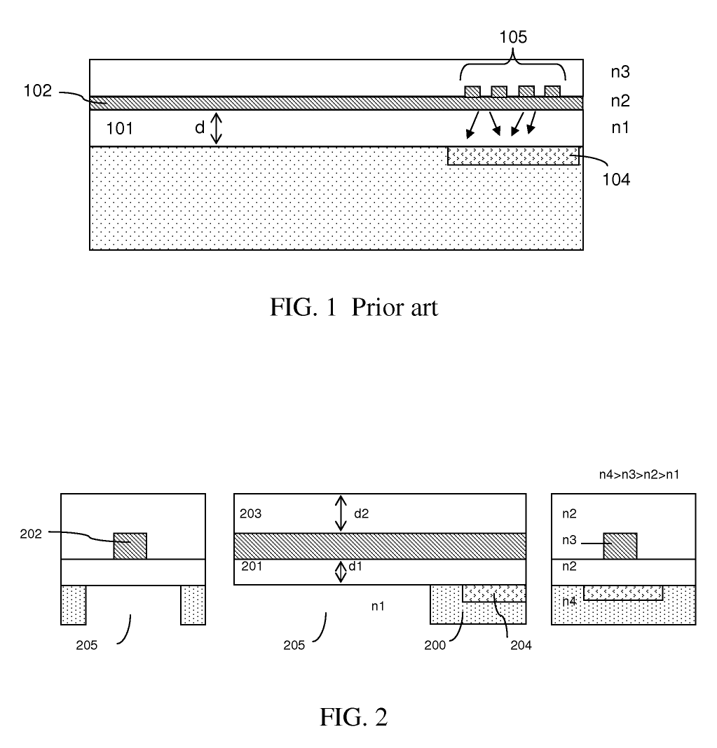

### DETAILED DESCRIPTION OF THE PREFERRED EMBODIMENTS

The preferred embodiments of the present invention disclose methods to reduce optical propagation loss, as well as, making it simpler to integrate waveguides to other on-chip functions, and to electronic circuits. On-chip functions can be photodetectors, tuning devices, modulator devices, dispersion compensation devices, etc. An embodiment of the present invention relates to the methods to reduce propagation loss due to evanescent coupling to the substrate by selectively etching away the substrate under the waveguides, thus leaving air filled trenches. Examples of how the preferred embodiments can improve the coupling efficient to the photodetectors, can improve the performances of waveguides to on-chip devices that utilized semiconductor-on-insulator substrate, can reduce losses in both photonic and electronic circuits, and can improve the sensitivity of an optical sensor will be highlighted.

It should be clear to those experienced in the art that the present invention can be applied and extended without deviating from the scope of the present invention.

Referred now to FIG. 2, a first preferred embodiment of the present invention is illustrated. On the left of the figure is the cross section of one end of the photoreceiver where light from the fiber is coupling in. The middle of the figure is the side view, and the right of the figure is the finishing end view. The photoreceiver consists of the waveguide, 202, and its upper cladding layer, 203, and bottom cladding layer, 201, sitting on top of the substrate, 200. The photodetector, 204, resides in the substrate, and is directly under the waveguide. Each of the layers has its refractive index, n. For total internal reflection, the refractive index of the waveguide core, n3, is larger than the refractive index of the cladding layer, n2. If the cladding layer is silicon oxide, then n2 is about 1.45. The substrate usually has very high refractive index number. For silicon substrate, the refractive index n4 is about 3.45 at 1.52 μm wavelength. Refractive index of air, n1, is 1.

In a standard waveguide design, the lower cladding's thickness, d1, is the same as upper cladding's thickness, d2. It also is designed to be thick enough to ensure no leaky loss from the optical field in the waveguide to the substrate. For low index waveguide, such as silicon oxynitride, where the index difference with the silicon oxide (used as cladding layer) is about 1 percent, d1 is at least 7 μm. Such low index waveguide is used because its mode field size is similar to that of the external single mode fiber; hence coupling loss between the fiber and the waveguide is less than 0.2 dB per facet. Using higher refractive index waveguide, such as silicon nitride which n is 2.05, the thickness of silicon oxide can be reduced to 2.5 to 3 μm. However, without a mode converter between the fiber and the high index waveguide, the coupling loss would be very high. In any case, the waveguide is still too far from the photodetector for any effective optical coupling.

To overcome the large distance, d1, prior arts use optical tap, optical grating coupler, stacked antiresonant reflecting optical waveguide coupler, or to form substrate with different heights, in order to improve the efficiency in getting guiding light to the photodetector.

In FIG. 2, the preferred embodiment is to remove the substrate under part of the waveguide; hence an air filled trench, 205, is formed. Since n of air is 1, the index difference with n2, refractive index of oxide cladding, is 0.45. Incident light from the evanescent field reaching the interface of cladding and air would reflect back when incident angle is larger than critical angle of 43.6 degree. Some of this reflecting light refract back to the waveguide core. This allows d1 to be thin, because most of the evanescent field would reflect back. In fact d1 can be zero. In other word, waveguide can be placed in the proximity of the photodetector, without worrying about the propagation loss.

The waveguide has two ends. One end is coupled to the fiber, and the other end is coupled to the photodetector. The end of the waveguide that is coupled to the photodetector can be etched to produce a slanted surface. This can further improve the optical coupling by reflection. Even further improvement can be made if the slanted surface is coated with light reflecting material such as aluminum or copper.

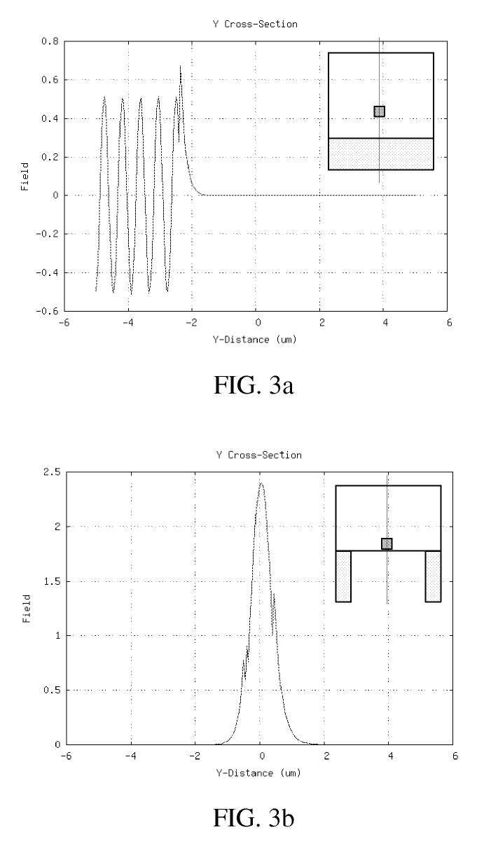

Using a 2D mode solver, LIGHTS, FIG. 3a shows the results of a 0.8 um×0.8 um silicon nitride waveguide sitting on a 2.5 μm oxide lower cladding and on top of a silicon substrate. The top cladding is also oxide with refractive index of 1.45. The center of the core is at the origin (0, 0) of the x- and y-axes. In the inset photo, a referenced y-axis is shown. Simulation is performed at wavelength of 1.52 μm. In this case, light couples strongly to the substrate. On the other hand, FIG. 3b shows the results of the embodiment. Even with 0.1 μm oxide as a lower cladding layer, light traverses along the waveguide with no coupling to either the silicon substrate or air; hence negligible propagation loss. Note the inset photo shows the top of the substrate is raised up to y equals −0.5 μm so that the substrate is only 0.1 μm from the waveguide.

Forming air filled trenches is achieved in the following manner. After all the processing steps on the front side of the wafer completed, the back side of the wafer will be thin down to a predetermined thickness. To form an ultra thin wafer, the original wafer would be attached to a holding substrate (i.e. glass substrate) on the front side. Using a combination of back side grinding and wet chemical etching, it has been reported that 200 mm diameter silicon wafer can be thinned down to 50 μm. Still with the holding wafer, after back side clean, standard photolithography processes will proceed, using alignment marks on the front side to align the trenches' features. The width of the trench should be larger the width of the waveguide. Also margin should be included in the calculation to account for anisotropic etching, should it be used. The next step is to etch silicon in the areas that are opened by the photolithography processes from the back side of the wafer until it reaches the bottom of the dielectric layer on the front side of the wafer. The selectively etching process can be by dry etch, wet etch, laser, focus ion beam or a combination of some of them. Current deep reactive ion etching, DRIE, process has silicon etch rate of more than 10 μm/min and 1:40 aspect ratio. The final steps are clean, resist strip, clean, dicing, and releasing from the holding substrate.

An alternate method is using the TAIKO process developed by DISCO in thinning wafer and in handling of wafer during the processing steps of photolithography, etching, cleaning, and dicing. More information about the method is disclosed on the website http://www.discosin.com.sg/eg/solution/library/taiko.html.

Depending on the waveguide material, and the design, the width of the trench varies. However, it is expected that in most cases the width is more than 4 μm. Hence, photolithography, etching, and cleaning steps in making the trench can be done with low grade mask and in a class 1000 clean room.

In summary, this embodiment requires only one extra masking step, and its associate etching, cleaning steps. This embodiment also does not disturb the standard integration on the front side of the wafer. Finally, it is a relatively low cost operation.

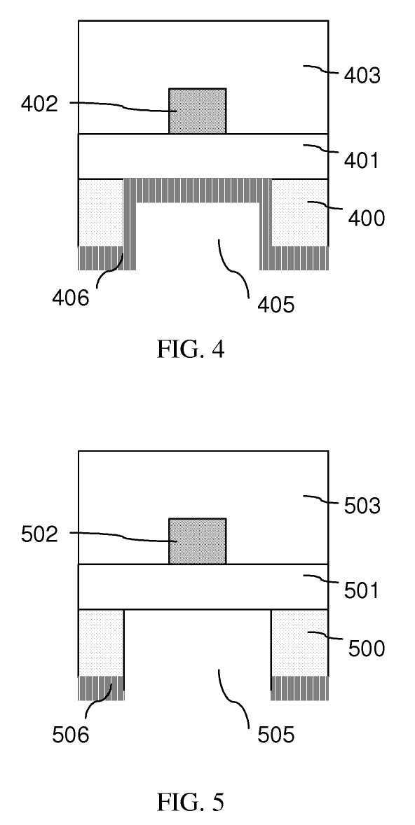

FIG. 4 shows the final structure, where the optical waveguide, 402, surrounding with the upper cladding layer, 403, and the lower cladding layer, 401, sits on a substrate, 400, that has some of its parts etched away, leaving an air filled trench, 405.

As an important, but optional feature, a low optical absorption metal layer, such as aluminum, copper or gold, is deposited on the back side of the wafer before dicing. It has been showed elsewhere that copper can be deposit in via with aspect ratio greater than 6. In FIG. 4 this metal layer, 406, provides a good grounding surface. Incident light would reflect back when it strikes the interface of oxide cladding and metal.

Refer to FIG. 5, a metal layer is used as a photoresist for photolithography step described previously. After selectively etching the substrate, the metal layer is not stripped away. The metal, 506, is used as a grounding surface without interfering the action of the waveguide.

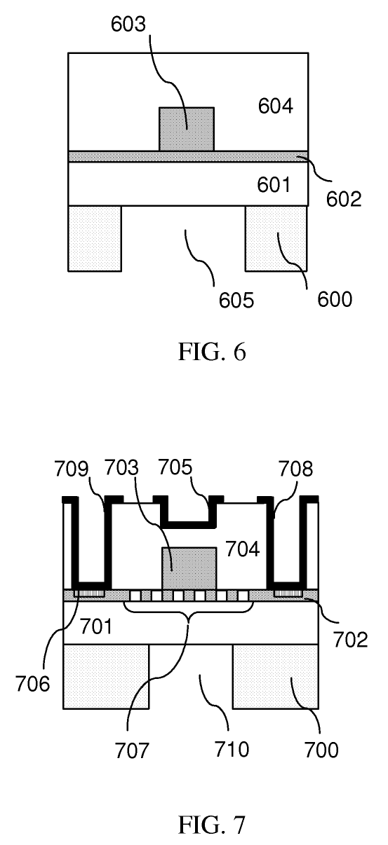

Reference is now made to FIG. 6, in which another exemplary embodiment of minimize propagation loss in optical devices with SOI substrate. There are advantages of using high index materials such as silicon nitride, tantalum oxide, aluminum oxide, and polymer over silicon for use as waveguide. Silicon waveguide has much higher scattering losses through its sidewalls because of the roughness scattering magnify for high index difference waveguides, and because silicon etch usually leaves its sidewall rough. It is also much more difficult to couple light from the fiber to silicon waveguide because its core size for single mode propagation is less than 300 nm. Here, high index waveguide sits directly on the top silicon layer, 602. However, with normal SOI wafer in which the buried oxide, BOX, thickness is between 350 to 1000 nm, the silicon nitride waveguide, 603, would have high propagation loss, due to coupling loss to the bottom silicon substrate or the “handle” substrate, 600. BOX, 601, thickness would have to be at least 2.5 μm for silicon nitride waveguide and much larger for other dielectric or polymer waveguides with refractive index smaller than silicon nitride. This presents a problem because BOX is growth by thermal oxidation. With wet oxidation growth rate of 1000 Angstrom per hour, it will take day to get BOX thicker than 2 μm. Also BOX uniformity and defects would be a concern for such thick BOX. Therefore, it is very difficult to obtain SOI wafer with BOX thicker than 1 μm. Another problem associates with thick BOX is heat dissipation. Compare to silicon, oxide is a poor heat sink.

Using air filled trench under the waveguide that is disclosed in the embodiment, there is no need for thick BOX in order to reduce the propagation loss. Here, the trench etching stops when it reaches the interface of BOX and “handle” substrate.

Refer to FIG. 7 is a modification of a dispersion compensation device that was disclosed by Ogawa and Tan in US patent application 20060093299. Here, the silicon nitride waveguide, 703, is layered directly on top of a 2 dimensional photonic crystal region, 707, which situates in the top silicon layer, 702. The waveguide has higher refractive index number than those of the upper cladding, 704, and the lower cladding, 701, layers. Incidentally, the lower cladding layer is the BOX of the SOI wafer. Outside the photonic crystal region, there are regions, 706, that are heavily doped. They can be either n-plus or p-plus. They will act as source and drain of a field effect transistor. Together with the gate electrode, 705, the drain electrode, 709, and the source electrode, 708, would control the carriers that are trapped at the interface states between the Si part of the photonic crystal region and the holes which is filled with silicon oxide film.

The photonic crystal region is used to control the chromatic dispersion variation. Depending on the design of the photonic crystal, (the ratio of hole radius, r, and the lattice interval, a,) optical waves propagating in a photonic crystal experience a negative or a positive dispersion. Hence the negative dispersion due to the photonic crystal would be used to compensate for the input optical waves that had positive dispersion. Likewise, the positive dispersion due to the photonic crystal would be used to compensate for the input optical waves that had negative dispersion.

The device works as followed. During optical pulses propagating through the fiber at high bit rate and over a long distance, they got distorted due to chromatic dispersion. Now when they are coupled to the dispersion compensation device, they would be coupled to the SiN waveguide. When they propagate through the photonic crystal region, portion of them leak to photonic crystal. The distortion would be corrected. With the help of the field effect transistor, which controls the carrier density in the photonic crystal region, the dispersion compensation actions become more effective. By the way, the propagation loss has to be kept to the minimum in order for the dispersion compensation to work reliably.

In this case, since light is supposed to propagate in the silicon nitride waveguide and is to have negligible propagation loss, the BOX thickness should be more than 2.5 μm. If such SOI wafer can not be found, then the air filled trench would be a good substitute. In FIG. 7, the air filled trench, 710, is designed under the waveguide with its width larger than the width of the waveguide, 703, but maybe smaller than the width of the photonic crystal region.

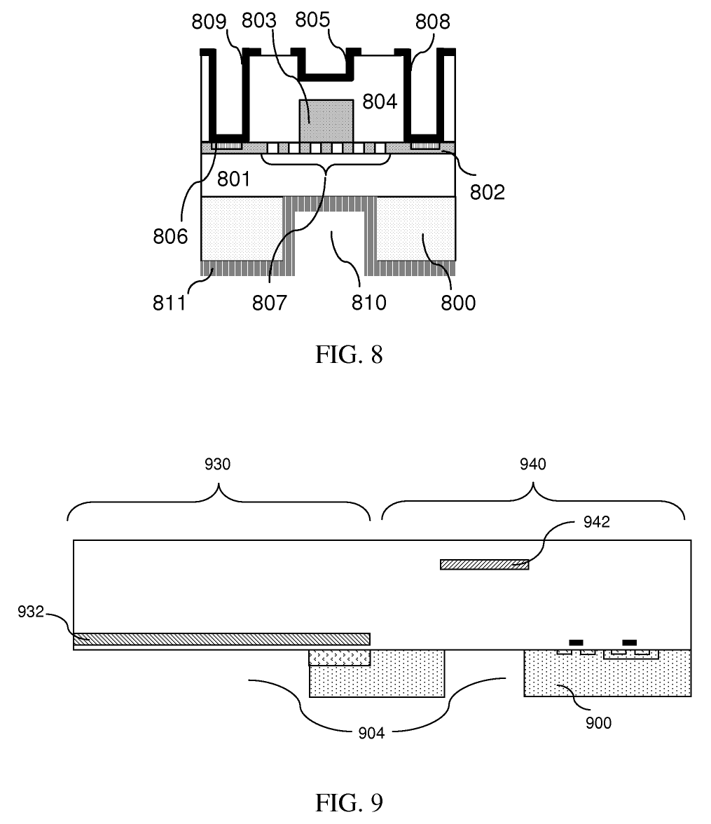

Moreover, another embodiment is disclosed as shown in FIG. 8. After an air filled trench was formed, a metal layer, 811, such as copper, gold, or aluminum, is deposited on the back of the SOI wafer. This forms a second gate. Because the second gate is right up underneath the BOX oxide, together with the original field effect transistor, it would help to control the carrier density in the photonic crystal region more effectively. The influence of the back gate is inversely proportional to the BOX thickness.

An embodiment of an integrated system is shown in FIG. 9. The integrated system includes the photonic circuits, 930, and electronic circuits, 940, on the same substrate, 900. One example is an optical transceiver circuit where optical waveguides, photodiode, modulator, and laser diode represent the photonic components and the transimpedance amplifier, modulation drivers, multiplexer and de-multiplexer, and laser driver represent the electronic circuits.

For 1.0 Gb/s transceivers and beyond, metal interconnects, 942, and other passive components such as inductors, MIM capacitors, start to have signal loss due to the lossy silicon substrate. Time varying signal travels along metal line would generate electric field and magnetic field that penetrate in the silicon substrate. The electric field would induced substrate current, whereas the magnetic field would induced eddy currents. Removing silicon beneath these components would minimize these losses. Therefore, air filled trenches, 904, by etching from the back side of the wafer can be applied to both photonic components, 932, and electronic components, 942, at the same time.

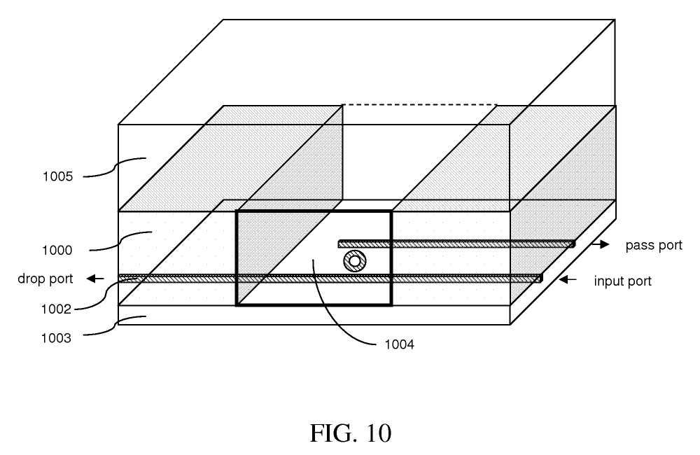

Finally, FIG. 10 shows that the trenches are useful if the PLC is used for sensing. Here the trench, 1004, can be used as a channel for gases or fluids to pass through or drop on. These gases and fluids alter the optical field in the waveguide, 1002, and these changes can be measured. The trench allows sensitive detection of small amounts of samples.

Also shown are the upper cladding, 1003, the substrate, 1000, and a cap, 1005. Here the optical sensor is based on micro-ring resonance and the trench or channel is perpendicular to the propagation light path. However, the same principle would work for optical sensors based on surface plasmon resonances, or interferometers, and the trench is parallel to the propagation light path.

Also shown in FIG. 10, the optical sensor is flipped upside down, the electrodes (not shown) can be solder bumped to a silicon bench (not shown) to gain access to the external inputs/outputs. Not shown in FIG. 10 are optional layers which can be deposited and formed to enhance the sensitivity of the sensor.

This embodiment provides a better alternative to building trenches or channels on the front side of the substrate. If monolithically integrated on the front side, thick film needs to be deposited on the front side, making the integration complicated, not only to form the flowing channels, but to gain access to the electrodes of the associated electronic circuits. If not monolithically integrated, then each channeling device has to mount on the sensor through delicate aligning and attaching and it is one at a time.

While the invention has been particularly shown and described with reference to the preferred embodiments thereof, it will be understood by those skilled in the art that various changes in form and details may be made without departing from the spirit and scope of the invention.

What is claimed is:

1. An integrated optoelectronic apparatus comprising:
a silicon handling substrate having a thickness, a top surface, a bottom surface, the bottom surface of the handling substrate is called the backside;
a buried insulator disposed above the top surface of the handling substrate;
a device layer disposed above the buried insulator, the device layer having a thickness, and the device layer having a first refractive index value;
a core of an optical waveguide formed on a top surface of the device layer, the core having a width, a length, and a height, the core having a second refractive index value, wherein the second refractive index value is smaller than the first refractive index value
a cladding layer called upper cladding layer disposed on the device layer and covering the core, the upper cladding having a third refractive index value, wherein the third refractive index value is smaller than the second refractive index value;
an on-chip device optically coupled to the core of said optical waveguide;
electrical contacts connected to said on-chip device;
an electronic circuitry operationally connected to the on-chip device;
an air filled trench located under the core of the optical waveguide and with a height extending from the backside to anywhere between a top surface of the handling substrate and a top surface of the buried insulator, wherein its width is larger than a width of the core of the optical waveguide; and
wherein said optical waveguide, said on-chip device, and said air filled trench under the optical waveguide form a low cost and high efficiency optoelectronic apparatus.

2. The apparatus of claim 1, wherein said semiconductor substrate material is selected from the group consisting of Si, SiGe, or Ge, and said core material is selected from the group consisting of silicon nitride, silicon oxynitride, Ge-doped oxide, tantalum oxide, titanium oxide, aluminum oxide, hafnium oxide, or polymer.

3. The apparatus of claim 1, wherein the on-chip device is made up of photonic crystal structures and it is formed in the device layer and below the optical waveguide.

4. The apparatus of claim 1, wherein the on-chip device is able to modulate amplitude and phase of light.

5. The apparatus of claim 1, further comprising a layer of metal such as Cu, Au, Al, AlCu, etc., lying on the backside of the substrate and inside the trench, wherein said metal layer acts as a ground plane or a back gate.

6. The apparatus of claim 1, further comprising of a buffer dielectric layer sandwiched between said device layer and said core of the waveguide, and said height of the air filled trench extends further from the backside to an interface of the buffer dielectric layer and the device layer.

7. The apparatus of claim 6, wherein the on-chip device forms in the device layer, and is able to generate light, or detect light.

8. The apparatus of claim 6, wherein the on-chip device has a mesa structure on said device layer, and is able to generate light, or to detect light.

9. The apparatus of claim 6, further comprising RF passive devices such as transmission lines, inductors, capacitors, antennas, etc., operating in the Giga Hertz range.

10. The apparatus of claim 9, wherein RF passive devices have air filled trenches under them, said air filled trenches are larger than the RF passive devices in footprint.

11. The apparatus of claim 1, further comprising a trench in said device layer, said the trench depth equaling the thickness of the device layer, wherein the core of the waveguide is disposed in the trench, and the core width is smaller than the trench width.

12. An integrated optoelectronic apparatus comprising:
a semiconductor substrate having a thickness, a top surface, and a bottom surface, the semiconductor substrate having a first refractive index value;
a buffer dielectric layer disposed above said semiconductor substrate, the buffer dielectric layer having a second refractive index value, wherein the second refractive index value is lower than the first refractive index value;
a core of an optical waveguide formed on said buffer dielectric layer, the core having a width, a length, and a height, the core having a third refractive index value, wherein the third refractive index value is larger than the second refractive index value
a cladding layer called upper cladding layer disposed on the buffer dielectric layer and covering the core, the upper cladding having a fourth refractive index value, wherein the fourth refractive index value is smaller than the third refractive index value
an on-chip device optically coupled to the core of said optical waveguide;
electrical contacts connected to said on-chip device;
an electronic circuitry operationally connected to the on-chip device;
an air filled trench located under the core of the optical waveguide and in the semiconductor substrate, wherein a width of the air filled trench is larger than the width of the core of the optical waveguide and an air filled trench depth starts from the top surface of the semiconductor substrate;
said integrated optoelectronic apparatus having a front side and a backside, wherein a top surface of said apparatus is the front side and a bottom surface of the semiconductor substrate is the backside; and
wherein said optical waveguide, said on-chip device, and said air filled trench under the optical waveguide form a low cost and high efficiency optoelectronic apparatus.

13. The apparatus of claim 12, wherein said semiconductor substrate material is selected from the group consisting of Si, SiGe, or Ge, and said core material is selected from the group consisting of silicon, silicon nitride, silicon oxynitride, Ge-doped oxide tantalum oxide, titanium oxide, aluminum oxide, hafnium oxide, or polymer.

14. The apparatus of claim 12, wherein the on-chip device forms in the semiconductor substrate and is able to generate light, detect light, amplify light, or modulate amplitude and phase of light.

15. The apparatus of claim 12, wherein the on-chip device has a mesa structure on the semiconductor substrate and being able to generate light, detect light, amplify light, or modulate amplitude and phase of light.

16. The apparatus of claim 12, wherein said height of the air filled trench extends from the top of the semiconductor substrate to at least 0.5 um below, if the selectively etching is done from the front side.

17. The apparatus of claim 12, wherein said height of the air filled trench extends from the backside to the top surface of the semiconductor substrate, if the selectively etching is done from the backside.

18. The apparatus of claim 12, further comprising RF passive devices such as transmission lines, inductors, capacitors, antennas, etc., operating in the Giga Hertz range.

19. The apparatus of claim 18, wherein RF passive devices having air filled trenches under them, wherein the air filled trenches are larger than the RF passive devices in footprint.

20. A method of forming an optical waveguide-on-chip device apparatus comprising:
providing a semiconductor substrate;
forming an on-chip device and an electronic circuitry operationally connected to said on-chip device;
placing an optical waveguide as close as possible to the on-chip device for best optically coupling;
forming air filled trench under the waveguide and in the semiconductor substrate to enhance the output signal of the apparatus.

21. An integrated optical sensor with air filled trenches comprising:
a semiconductor substrate;
optical sensing elements disposed on the semiconductor substrate and part of them exposing to the air filled trench, wherein designing the structure and the dimensions of the optical sensing elements is based on surface plasmon resonances, or interferometers, or micro-ring resonances;
a thin film coated on the optical sensing elements to enhance the sensitivity of the sensor;
on-chip devices capable of generating or detecting light, said forming in the substrate and optically coupled to the optical sensing elements;
an electronic circuitry operationally connected to said on-chip devices;
an air filled trench formed the physical boundaries whereby the optical sensing elements exposing to the air;
a cap attached to the backside of the substrate, said the cap together with the air filled trench forming a hollow passage, wherein the hollow passage is where a gas or a fluid flowing through and being sensed by the optical sensing elements.
